(19) United States
(12) Patent Application Publication
(10) Pub. No.: US 2013/0096961 A1
(43) Pub. Date: Apr. 18, 2013

(54) System and Method for Electronic Ticket Exchange and Delivery

(71) Applicants: Evan Owens, Santa Monica, CA (US); Daniel Simon, Santa Clara, CA (US)

(72) Inventors: Evan Owens, Santa Monica, CA (US); Daniel Simon, Santa Clara, CA (US)

(73) Assignee: PogoSeat Inc., Santa Monica, CA (US)

(21) Appl. No.: 13/272,123

(22) Filed: Oct. 12, 2011

(51) Int. Cl. G06Q 10/02

(52) U.S. Cl. 705/5

(57) ABSTRACT

A system and method are described to electronically exchange seat tickets before or during an event in a way that eliminates the need to print or possess a paper ticket for a new seat while ensuring authenticity of the new electronic seat ticket. The system and method overcome current logistical constraints of upgrading a ticket during an event, and offers event attendees an option for exchanging their previously purchased ticket before or during an event.

### BACKGROUND OF THE INVENTION

1. Field of the Invention

The present invention relates generally to electronic ticketing, particularly electronic ticket delivery.

2. Description of the Prior Art

Many objects associated with live entertainment and sporting events, such as tickets, are often unsold at the start of an event. In many instances, the objects cannot be effectively sold due to their ever-diminishing value as the event approaches its finale, and the inability of the hosting venue to manage the sales in a logistically feasible manner. The most effective method to redeem value from these objects is to sell them as an upgrade for event attendees who have already purchased an object. If these objects are not sold or monetized by the end of the event, they have zero value. For example, if a baseball ticket is not sold at the beginning of the event, the ticket will likely not be sold during the event, and will therefore have no value to the venue. If, however, the baseball ticket can be offered as an upgrade to an existing fan in the venue, then the ticket can be monetized.

Existing methods to upgrade tickets during an event have logistical constraints that are cumbersome and inconvenient for event attendees. To offer a ticket upgrade during the event, for example, the venue must first provide the attendee with some means to view tickets that are available for sale as upgrades. Once the attendee has decided to upgrade a ticket and selected the desired ticket for upgrading, he or she must be able to purchase and secure the ticket for his/her exclusive use. And, once the attendee has purchased an upgraded ticket, the venue must transfer ownership of the ticket securely to ensure that the venue can validate the authenticity of the upgraded ticket and confirm that the attendee has ownership of the original ticket.

One way to securely sell and transfer upgraded tickets is to centralize sale and distribution of the upgraded tickets via a kiosk or other physical distribution point within the venue. This solution requires that an attendee queue (and wait) to purchase an upgraded ticket, thus missing out on the experience (e.g., a game or a concert) for which the attendee paid by purchasing the original ticket, and likely dissuading the attendee from purchasing an upgraded ticket. Furthermore, the physical limitation of a kiosk or similar distribution point would prevent the venue from being able to process an optimal number of ticket upgrades, since upgrades would have to be processed serially—rather than in parallel—so that the same upgrade ticket is not sold to multiple attendees. These factors would result in an unfavorable return on investment relative to the costs that would be associated with offering ticket upgrades.

In addition to ticket sale and distribution, ticket verification presents a challenge. A ticket is typically verified visually at predetermined checkpoints throughout the venue. Electronic equipment (e.g., scanners) used at venue entrances to authenticate original tickets is not, in most cases, available at every checkpoint within the venue. Thus, venue employees must have the ability to authenticate newly upgraded tickets without the use of an electronic device.

### SUMMARY

In one embodiment is an electronic ticketing method comprising: receiving at a computing system a communication across a network connection from a mobile device, the communication including identification of one or more current seat ticket at an event and a request for one or more new seat ticket at the event; determining by the computing system a price for the one or more current seat ticket; determining by the computing system one or more available seat ticket at the event and a price for each of the one or more available seat ticket; calculating by the computing system a change cost for the one or more available seat ticket based on a difference between the one or more current seat ticket price and each of the one or more available seat ticket price; communicating from the computing system across the network connection to the mobile device an indication of the one or more available seat ticket at the event and the change cost for the one or more available seat ticket; receiving at the computing system across the network connection from the mobile device one or more selected seat ticket from the one or more available seat ticket; receiving at the computing system an electronic delivery point for each one or more selected seat ticket; and communicating each one or more selected seat ticket to the received electronic delivery point.

In another embodiment is the above electronic ticketing method further comprising before the step of communicating each one or more selected seat ticket to the received electronic delivery point: calculating by the computing system a final cost for the one or more selected seat ticket based on the change cost for the one or more selected seat ticket; communicating from the computing system across the network connection to the mobile device the final cost; determining at the computing system billing information for the final cost; and receiving at the computing system across the network connection from the mobile device a confirmation to charge the final cost using the billing information.

In yet another embodiment is a system for mobile device-enabled electronic ticketing comprising: a computing system configured to communicate through a network connection with a mobile device to identify one or more current seat ticket and to receive a request from the mobile device for one or more available seat ticket at an event; and a venue store comprising information about seat tickets including a price for each of the seat tickets and an indication of whether each of the seat tickets is available for sale; wherein the computing system is further configured to communicate with the venue store to determine a price for each one or more current seat ticket and to identify one or more available seat ticket at the event and the ticket price for each of the one or more available seat ticket; determine a change cost for each of the one or more available seat ticket, the change cost for each of the one or more available seat ticket being based on a difference in price between the one or more current seat ticket and the one or more available seat ticket; communicate to the mobile device an indication of the one or more available seat ticket and the change cost for each of the one or more available seat ticket; receive from the mobile device one or more selected seat ticket from the one or more available seat ticket; receive from the mobile device one or more electronic delivery point for the one or more selected seat ticket; and communicate the one or more selected seat ticket to the received one or more electronic delivery point.

In another embodiment is the above system wherein the computing system is further configured to calculate a final cost for the one or more selected seat ticket based on the change cost for the one or more selected seat ticket; communicate the final cost to the mobile device; determine billing information for the final cost; and receive from the mobile device a confirmation to charge the final cost based on the billing information.

In another embodiment is anon-transitory computer readable medium having stored thereupon computing instructions comprising: a code segment to receive at a computing system a communication across a network connection from a mobile device, the communication including identification of one or more current seat ticket at an event and a request for one or more new seat ticket at the event; a code segment to determine by the computing system a price for the one or more current seat ticket; a code segment to determine by the computing system one or more available seat ticket at the event and a price for each of the one or more available seat ticket; a code segment to calculate by the computing system a change cost for the one or more available seat ticket based on a difference between the one or more current seat ticket price and each of the one or more available seat ticket price; a code segment to communicate from the computing system across the network connection to the mobile device an indication of the one or more available seat ticket at the event and the change cost for the one or more available seat ticket; a code segment to receive at the computing system across the network connection from the mobile device one or more selected seat ticket from the one or more available seat ticket; a code segment to receive at the computing system an electronic delivery point for each one or more selected seat ticket; and a code segment to communicate each one or more selected seat ticket to the received electronic delivery point.

In yet another embodiment is the above non-transitory computer readable medium further comprising: a code segment to calculate by the computing system a final cost for the one or more selected seat ticket based on the change cost for the one or more selected seat ticket; a code segment to communicate from the computing system across the network connection to the mobile device the final cost; a code segment to determine at the computing system billing information for the final cost; and a code segment to receiving at the computing system across the network connection from the mobile device a confirmation to charge the final cost using the billing information.

### BRIEF DESCRIPTION OF DRAWINGS

FIG. 1 depicts one embodiment of a system for electronic ticket exchange and distribution.

FIG. 2 is an exemplary process flow of one embodiment of a method to electronically exchange and deliver a ticket during an event.

FIG. 3 is an exemplary process flow detailing steps for ticket validation before delivery of an electronically exchanged ticket, according to one embodiment.

### DETAILED DESCRIPTION OF THE INVENTION

A system and a method are provided to deliver tickets to a user who exchanges (upgrades or downgrades) his current seat(s) for one or more different seat at the same event within the same venue in a way that eliminates the need to print or possess a physical ticket for the new seat(s). The venue itself can be an arena, a theater, a stadium, an amphitheater, a concert hall, or any such location where a ticket of some sort is necessary for attendance. Access to the electronically delivered ticket is restricted to a single user-defined device so as to prevent users from sharing a single electronic ticket via an electronic delivery mechanism (e.g., email, text message, or Bluetooth™ connection) and to prevent fraudulent tickets from being introduced into the venue. The system and method presented herein are explicitly contemplated to deliver tickets before an event at a venue, or preferably during an event at a venue.

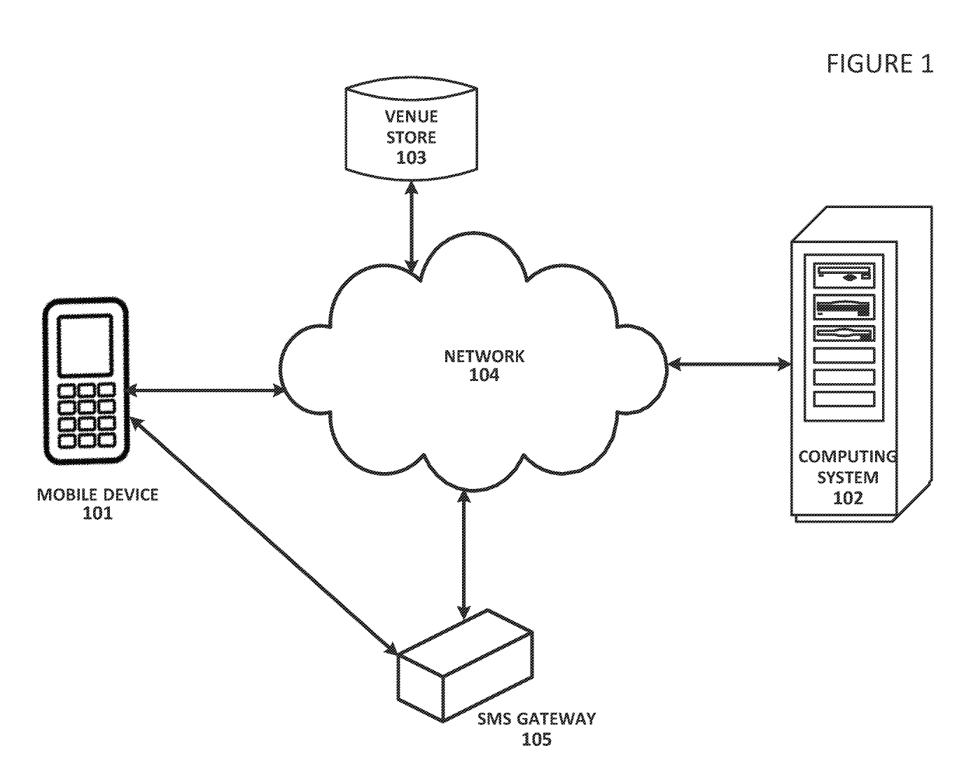

FIG. 1 shows one embodiment of the system to electronically exchange and deliver one or more ticket. A computing system 102 (preferably a computer server) communicates through a network 104 with a mobile device 101 running a web browser. One of skill in the art will recognize that mobile device 101 can also run a standalone application to communicate across network 104 with computing server 102 in a client-server model. Mobile device 101 is preferably a smartphone (such as the iPhone from Apple, Inc., a BlackBerry device from Research in Motion Limited, or a phone running the Android OS from Google, Inc. of Mountain View, Calif.), but can be any web-enabled mobile device with a user interface such as a phone, personal digital assistant (PDA), media device (such as the iPod or iPod Touch from Apple, Inc.), electronic tablet (such as an iPad from Apple, Inc., or the HP Slate from Hewlett-Packard Development Company, LP), or an electronic reader device (such as the Kindle or Kindle DX from Amazon.com, Inc. of Seattle, Wash., or The Reader from SONY Electronics Inc.).

Computing system 102 is connected via network 104 to venue store 103 (preferably a database) which contains information about seats within a venue, including, without limitation, a ticket price and a ticket identification for each of those seats, and preferably including an indication of whether a ticket for each seat is already purchased not available for exchange), available for exchange (including seat tickets not sold for an event and seat tickets originally sold but later exchanged for new seat tickets—i.e., abandoned seat tickets), reserved for exchange (reserved, but not yet purchased—i.e., in the process of being exchanged), exchanged (purchased but not yet communicated to mobile device 101 for electronic display), or redeemed (purchased and either already used. for admittance at the venue before or during an event, or communicated to mobile device 101 for electronic display). Computing system 102 accesses venue store 103 to process ticket requests initiated by the client application running on mobile device 101. One of ordinary skill in the art will recognize that venue store 103 can be a relational database, an object-oriented database, an operational data store, or a schema-less data store such as a distributed data store.

One of ordinary skill in the art will understand that network 104 can be a combination of wired and/or wireless networks, a wide area network (WAN), a local area network (LAN), a global area network (GAN), a virtual private network (VPN), a personal area network (PAN), an enterprise private network, or any similar network now known or later developed. One of ordinary skill in the art will further understand that each network connection can be, without limitation, an integrated services digital network (ISDN), a broadband ISDN (B-ISDN), a digital subscriber line (ADSL, ADSL+2), a symmetric digital subscriber line (SDSL), a very high speed DSL (VDSL), cable, cellular telephone, wireless, a broadband internet connection, a T-1 line, a bonded T-1 line, a T-3 line, an optical carrier level 3 (OC3), a satellite, or any other form of network connection now known or later developed.

Computing system 102 connects through network 104 to a Short Message Service (SMS) gateway 105 to deliver a seat ticket as an SMS text message. Alternatively, computing system 102 can deliver the seat ticket through network 104 to mobile device 101 (where mobile device 101 is the same or different from mobile device 101 running the web browser or client application) as an email message.

One of ordinary skill in the art will recognize that computing system 102, venue store 103, network 104, and SMS gateway 105 can each be located locally at the venue or remotely outside the venue.

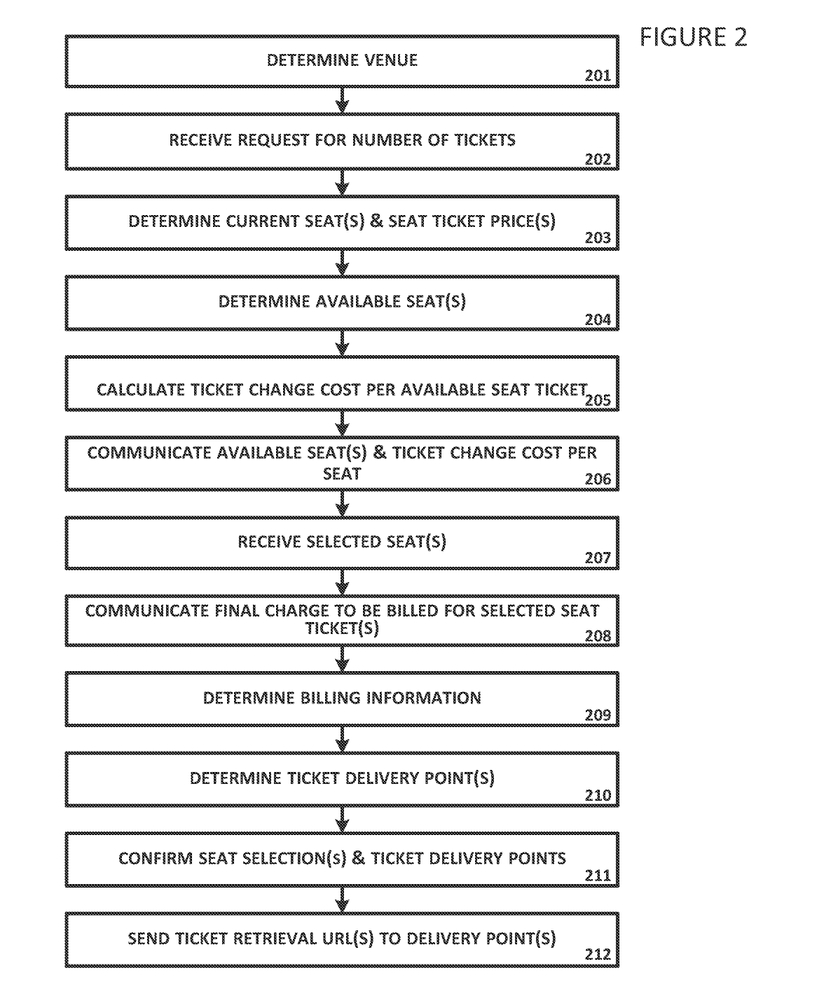

A process flow for one embodiment of the method to electronically exchange and deliver a ticket is detailed in FIG. 2. In this embodiment, the user accesses a web browser or application on mobile device 101 to request a seat ticket exchange. Once a network connection has been established, in step 201, computing system 102 determines the venue of the event for which a ticket is to be exchanged. Computing system 102 preferably identifies the venue based on data input through mobile device 101. For example, the user can be prompted to enter a zip code into mobile device 101 (which zip code can be used by computing system 102 to determine the venue), the user can select a venue from a pull-down menu of possible venues, the user can enter the name of the venue, or computing system 102 can use interact and/or computer geolocation techniques to determine the location of the mobile device 101 to determine the venue. These geolocation techniques associate “a geographic location with an Internet Protocol (IP) address, Media Access Control (MAC) address, radio-frequency identification (RFID), hardware embedded article/production number, embedded software number (such as a universally unique identifier (UUID), an exchangeable image file format (Exif)/international press telecommunications council (1PTC)/extensible metadata platform (XMP), or modern steganography), connection location, or device global positioning system (GPS) coordinates, or other, perhaps self-disclosed information. Geolocation usually works by automatically looking up an IP address on a WHOIS service and retrieving the registrant's physical address,”

http://en.wikipedia.org/wiki/Geolocation.

In step 202, computing system 102 receives across network 104 from mobile device 101 (preferably based on data input to mobile device 101 from the user) a request to exchange one or more currently-owned ticket (hereinafter “current ticket”) issued for one or more respective seat (hereinafter “current seat”) at the venue in return for one or more ticket (hereinafter “available ticket”) for one or more respective available seat at the same venue. The current seat ticket(s) can be redeemed or unused (i.e., purchased, but not yet redeemed at the venue, as for example, if the venue has not yet opened for the event). One of skill in the art will recognize that the current ticket may be a physical ticket (e.g., paper) or an electronic ticket.

In step 203, computing system 102 determines each current seat intended for exchange and determines the ticket price for each current seat. Computing system 102 determines each current seat preferably through user input (preferably entered as the seat number, section, and row for each current seat) received from mobile device 101, although determination through geolocation of mobile device 101 to determine the current seat of the user is also contemplated. Computing system 102 preferably accesses venue store 103 to determine the current ticket price for each current seat. The current ticket price of each current seat can be determined by accessing from venue store 103 the current ticket price of each current seat independently or, if the seats are grouped by price, by determining the current ticket price for a group (or section) of identically-priced seats. The current ticket price for the current seat(s) may also be determined by data input by the user through mobile device 101.

In step 204, computing system 102 accesses venue store 103 to determine which seats within the venue are available for sale and to determine the price for each available seat.

In step 205, computing system 102 calculates a ticket change cost to be charged for each available seat. The ticket change cost for each available seat is based in part on the price of the ticket for the available seat, but can be adjusted (preferably discounted) with a multiplier to reflect the desirability of the available seat. If the multiplier is less than one, the ticket change cost will be discounted relative to the price for the available seat ticket, and if the multiplier is greater than one, the ticket change cost will be increased relative to the price for the available seat ticket. The ticket change cost can also be adjusted to include venue or provider surcharges. The desirability of each seat can be determined by computing system 102, the venue, or by an event-associated entity (such as a sports team) and can be manually or automatically adjusted (discounted or increased) based on the inherent desirability of the available seat (or seat section). The desirability of the available seat (or seat section) can be influenced by, as non-limiting examples, the original price of the available seat, the number of available seats, the inherent desirability of the event at the venue (e.g., a World Series game would be more desirable than a minor-league ball game), and/or an occurrence at the event (such as the status of the event (e.g., just beginning versus approaching end of game) and/or event-associated entity triggers (e.g., a small difference in points between football teams may trigger an increase in the change cost for seats located near the end-zone for the leading team)). The ticket change cost can be calculated individually for each available seat, or can be calculated once for all available seats within a price-equivalent seat section.

In step 206, computing system 102 communicates across network 104 to an application running on mobile device 101 one or more available seat and the ticket change cost for each. The available seat(s) can be communicated to mobile device 101 as individual seats, or alternatively, as one or more section of available seats in which the ticket change cost is the same for each seat within any one grouping. Thus, for example, the available seats(s) can be communicated to mobile device 101 as seats 15A at change cost X, 23B at change cost Y, 24B at change cost Y, 25B at change cost Y, and 10C at change cost Z. Or, as another example, the available seat(s) can be communicated to mobile device 101 as five unspecified seats in section 215 at a change cost of X for each, one unspecified seat in section 101 at a change cost of Y for each, and 15 unspecified seats in section 307 at a change cost of Z for each.

In step 207, computing system 102 receives across network 104 from mobile device 101 one or more seat selected by the user from the available seat(s) provided by computing system 102 (hereinafter “selected seat(s)”). Alternatively, computing system 102 receives from mobile device 101 one or more section selected by the user from the available section(s) provided by computing system 102 in step 206. If computing system 102 communicates one or more section of available seats (and associated change cost(s)) to mobile device 101 in step 206, and computing system 102 receives from mobile device 10) selected section(s) of available seats in step 207, then computing system 102 again performs step 206 and 207 to allow the user of mobile device 101 to select one or more available seat within the selected section(s).

In step 208, computing system 102 determines a final charge to be billed for the selected scat(s) and communicates the final charge across network 104 to mobile device 101. The final charge is based on the summed ticket change cost(s) for the selected seat(s) but may also include fees, surcharges, and taxes as necessary.

In step 209, computing system 102 determines billing information for the final charge. Billing information may be obtained from mobile device 101 (e.g., user-input data) or may be retrieved by computing system 102 from a user account. If the billing information from mobile device 101 is user-input data, computing system 102 may give the user (through mobile device 101) the option to generate an account to store billing and other information for future use. Computing system 102 preferably completes the financial transaction at this point (i.e., uses the determined billing information to charge the transaction, for example, to a credit card or an electronic payment service such as PayPal).

In step 210, computing system 102 determines and associates one or more delivery point (e.g., email address or phone number) with each selected seat ticket. Tickets can be delivered through various channels including, for example, by email or preferably, by SMS text message. A separate delivery point can be associated with each selected seat ticket, a single delivery point can be associated with all of the selected seat tickets, or several delivery points, each for one or more selected seat ticket, may be determined. One or more delivery point can be received across network 104 from mobile device 101 (e.g., user-input data), or may be retrieved by computing system 102 from the user account. It is to be understood that a delivery point can be the same mobile device 101 communicating with computing system 102 to select and buy the seat ticket(s) or a different mobile device 101. Alternatively, the user can identify an individual to be the recipient, and the web browser or application running on mobile device 101 can access an address book on mobile device 101 to identify the delivery point (e.g., email address or cellular phone number) for that individual.

In step 211, computing system 102 communicates across network 104 to mobile device 101 a confirmation of the transaction. The confirmation can include, without limitation, instructions on how to retrieve and redeem the ticket(s) for the selected seat(s), identification of the selected seat(s), the current seat(s) to be exchanged, the one or more associated delivery point, the ticket change cost(s) for the ticket(s) for the selected seat(s), the final charge, and/or the billing information.

In step 212, ticket retrieval instructions are sent electronically by computing system 102 to the delivery point(s) with one or more one-time universal resource locator (URL). Each URL provides a browser link to access the electronic seat ticket fix the respective selected seat. As an example, a user can request that the tickets for selected seats A and C be delivered electronically to phone X and that the ticket fix selected seat B be delivered electronically to email Y. Ticket retrieval instructions and a first URL to access the ticket for selected seat A, as well as a second URL to access the ticket for selected seat C are then sent as one SMS text message (or as two text messages) to phone X. Ticket retrieval instructions and a third URL to access the ticket for selected seat are sent to email Y.

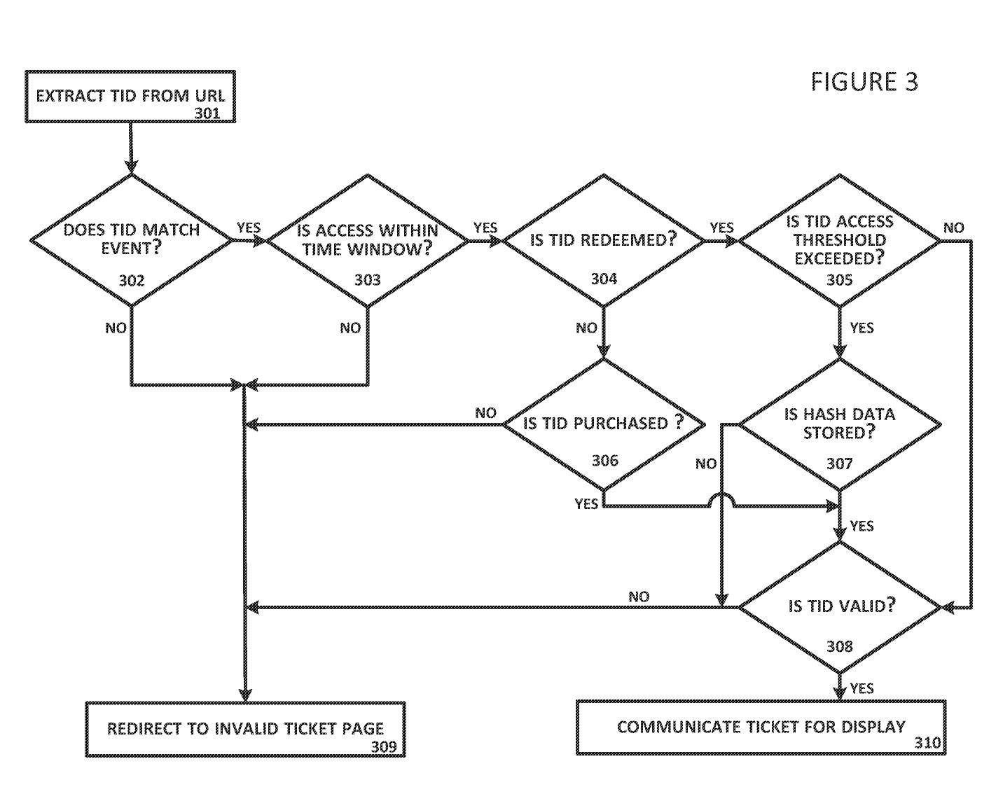

When the user clicks on he delivered URL, the web browser on mobile device 101 establishes communication with computing system 102 and the ticket associated with that URL is validated through a series of steps as outlined in FIG. 3. The validation steps ensure that the ticket is not counterfeit, and that the ticket is being redeemed for the correct event. Preferably, each URL is minified (as for example, through a URL shortening service (e.g., bitly™) before being sent. The URL is constructed as follows: http://www.pogoseat.com/seat_validation/t<TID>/<TIME_STAMP><PEPPERED_HASH>

### Where:

<TID>=system generated ticket id (resulting from an auto-incremented value)
<TIME_{——}STAMP>=system generated timestamp
<PEPPERED_HASH>hash(<BASE_URL>+<TIME_STAMP>+<TID>+<PEPPERED_KEY_WITH TID >) (where hash can be md5, sha1, sha256, sha512, DES, or any other hashing algorithm)
<BASE_URL>=<POGOSEAT_URL>+′/seat_validation/t′+<TID>
<POGOSEAT_URL>=system defined URL, i.e. http://www.pogoseat.com)
<PEPPERED_KEY_WITH_TID>=<PEPPER_ARRAY>[<TID>%count(<PEPPER_ARRAY>)][rand(0,count(<PEPPER ARRAY_ROW>))]
<PEPPER_ARRAY>=a 2-D array comprised of randomly generated salts
<PEPPER_ARRAY_ROW>=<PEPPER ARRAY>[<TID>%count(<PEPPER_ARRAY>)]

In step 301, computing system 102 extracts the system-generated ticket identification (“TID”) from the URL and uses the TID to look up the ticket referenced by that identification number in venue store 103.

In step 302, computing system 102 determines whether the extracted TID matches a ticket identification number in venue store 103. If the TID does not match a TID in venue store 103 (e.g., if the TID is not for the venue, or not for the correct event at the venue), the user is redirected to an invalid ticket webpage 309.

If in step 302, computing system 102 determines that the TID matches a ticket identification number within venue store 103 (i.e., the ticket is for the specified event/venue), then, in step 303, computing system 102 determines whether the ticket referenced by the TID is being accessed within a system-determined time window [e.g., and consistent with the above discussion regarding the URL: <TIME_STAMP>+<ALLOWED_REDEEMED_TIME> <<SYSTEM_TIME>, where <ALLOWED_REDEEMED_TIME>=an amount of time specified by the venue that a ticket is valid (in seconds). For example, <ALLOWED_REDEEMED_TIME> may be 3600 seconds (1 hour)]. The system-determined time window may he determined by computing system 102, the venue, or an event-associated entity and is preferably a time period approximating the duration of the event at the venue for which the ticket has been purchased, although the time window may also be longer or shorter than that time period. If the ticket referenced by the TID is not being accessed within the system-determined time window, then the user is redirected to an invalid ticket webpage 309.

If, in step 303, computing system 102 determines that the ticket reference by the TID is being accessed within the system-determined time window, then, in step 304, computing system 102 determines whether the ticket referenced by the TID has been redeemed. P If, in step 304, computing system 102 determines that the ticket reference by the TID has been redeemed, then, in step 305, computing system 102 determines whether the ticket referenced by the TID has been accessed more than a system-defined threshold number of times (e.g., 3 times)

If, in step 305, computing system 102 determines that the ticket referenced by the TID has not been accessed more than a system-defined threshold number of times, then, in step 308, computing system 102 determines whether the TID is valid. Computing system 102 does this by validating the <PEPPERED_HASH> supplied in the URL by reverse engineering the hash using known values from venue store 103, checking the timestamp, and by using a pepper mechanism as known in the art. If computing system 102 determines that the TID is not valid, the user is redirected to an invalid ticket webpage 309.

If, in step 308, computing system 102 determines that the TID is valid, then in step 310, computing system 102 retrieves the electronic ticket referenced by the TID, communicates the ticket to the browser on mobile device 101 for display, and the user's browser is redirected to a webpage where the electronic ticket referenced by the TID is displayed. The first time the ticket is viewed on mobile device 101, a <HASH_VALUE> is saved to mobile device 101 using a <HASH_KEY> as reference (i.e. for a cookie, the cookie name is <HASH_KEY> and the cookie value is <HASH_VALUE>, whereas for local storage, the key is <HASH_KEY> and the key value is <HASH_VALUE>). For example, the stored hashed data can be:
<HASH_KEY>=hash(<MESSAGE>) (where hash can be md5, sha1, sha256, sha512, DES, or other hashing algorithm)
<HASH_VALUE>=pepper(<MESSAGE>,<TID>)
<MESSAGE>=“v=”+<VENUE_ID>+“:ve=”+<VENUE_EVENT_ID>+“:os=”+<OLD_SEAT_{'}NUMBER>+“:or=”+<OLD_ROW>+“:osc=”+<OLD_SECTION>+“:ns=”+<NEW_SEAT_NUMBER>+“:nr=”+<NEW_ROW>+“:nsc=”+<NEW_SECTION>+“:p=”+<PRICE_PAID>
<VENUE_ID>=a unique, internal system generated identification for the venue hosting the event and associated to the ticket.
<VENUE_EVENT_ID>=a unique, internal system generated identification for the event at that venue associated with the venue from which the ticket was purchased.
<OLD_SEAT_NUMBER>=a seat number associated with the original purchased ticket (i.e., the seat number associated with the current seat)
<OLD_ROW>=a seat row associated with the original purchased ticket (i.e., the row associated with the current seat)
<OLD_SECTION>=a seat section associated with the original purchased ticket (i.e., the section associated with the current seat)
<NEW_SEAT_NUMBER>=a new number associated with the purchased selected ticket.
<NEW_ROW>=a new row associated with the purchased selected ticket.
<NEW_SECTION>=a new section associated with the purchased selected ticket,
<PRICE_PAID>=a price paid for the purchased selected ticket.

The communicated electronic ticket contains, at a minimum, the selected seat location, but can also contain additional information including, without limitation, a date of the event, the location of the current seat (i.e., the seat exchanged for the selected seat), an event name, avenue address, and/or other information. The ticket will also preferably contain a unique passphrase generated, e.g., specifically for that event on that day at that venue. This unique passphrase further prevents a ticket from being forged and can serve as a final authentication of the ticket by a venue employee when the user presents the ticket as he moves to the selected seat. The unique passphrase may also be animated, displaying individual words in the passphrase in succession, one at a time. This would act to prevent screen capturing software from being able to capture and save an image of the ticket.

Once a ticket is delivered to the user, the user can simply go to the usher at the venue and show him the new electronic ticket (for the selected seat) on his mobile device and the current seat ticket in his/her possession. The usher verifies that the passphrase on the electronic ticket matches the venue- or event-correct passphrase, preferably verifies that the old ticket seat location matches that location information on the new electronic ticket, and preferably verifies that the new electronic ticket is for the user's (newly ticketed) selected seat. The passphrase is preferably changed on a regular basis (preferably daily), and may be different for different sections (or other groupings) at the venue.

Returning to step 304, if the ticket referenced by the TID has not been redeemed, then, in step 306, computing system 102 determines whether the ticket referenced by that TID has been purchased. If the ticket referenced by the TID has not been purchased, then the user is redirected to an invalid ticket webpage 309.

If, in step 306, computing system 102 determines that the ticket referenced by the TID has been purchased, then computing system 102 determines whether the TID is valid (step 308, as discussed above). Depending on the outcome of that determination, computing system 102 communicates the ticket to the browser for display (step 310) or redirects the user to an invalid ticket webpage (step 309).

Returning to step 305, if computing system 102 determines that the ticket has been accessed more than a system-defined threshold number of times (e.g., 3 times), then, in step 307, computing system 102 determines whether a hashed piece of data (originally stored as discussed above in step 310) is currently stored in either a cookie or in local storage (e.g., in the case of HTML5 only) on mobile device 101. Using stored hash data generated with a high level of encryption and a peppering mechanism (in which the known piece of hashed data comprises several random values (“pepper”) which are preferably known only by venue store 103) to validate mobile device 101 minimizes the likelihood that non-authorized transfer of the ticket can occur.

If, in step 307, the <HASH_VALUE> is not found on the device, then the user is redirected to an invalid ticket webpage 309 with instructions on how to remedy the situation.

If, in step 307, computing system 102 determines that the <HASH_VALUE> is stored on mobile device 101 (i.e., that the ticket has been displayed at least once), then computing system 102 determines whether the TID is valid (step 308, discussed above), and depending on the results of that decision, communicates the ticket to the browser for display (step 310, discussed above) or redirects the user to an invalid ticket webpage (step 309, discussed above).

It is to be understood that the examples given are for illustrative purposes only and may be extended to other implementations and embodiments. For example, the embodiments of the system and method discussed herein are described in terms of upgrading an object (e.g., a ticket), although one or ordinary skill in the art wilt understand that the system and method are explicitly contemplated to encompass downgrading an object, as for example if an attendee of an event decided to exchange his original seat for a cheaper seat further away from the stage for a “zoomed-out” view, or to effectively lower the sound. While a number of embodiments are described, there is no intent to limit the disclosure to the embodiment(s) disclosed herein. On the contrary, the intent is to cover all alternatives, modifications, and equivalents apparent to those familiar with the art.

It is to be understood that the processes and embodiments described herein can be run on a web browser, a browser-based application, a standalone application, or any combination thereof on mobile device 101 operating as a client-server model with computing system 102.

Further, the processes and embodiments described herein, along with the ancillary functions such as device communications, and device display generation, etc., can all be implemented in software stored in a computer readable storage medium as needed to run such software on the appropriate processing hardware of the various devices described herein.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. Thus, for example, although a number of examples herein reference sporting events, the system and method described herein apply equally to other events (e.g., plays, movies, concerts, ceremonies, etc.) and to non-sporting venues (e.g., arenas, theaters, auditoriums, opera houses, etc.) The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. An electronic ticketing method comprising:
receiving at a computing system a communication across a network connection from a mobile device, the communication including identification of one or more current seat ticket at an event and a request for one or more new seat ticket at the event;
determining by the computing system a price for the one or more current seat ticket;
determining by the computing system one or more available seat ticket at the event and a price for each of the one or more available seat ticket;
calculating by the computing system a change cost for the one or more available seat ticket based on a difference between the one or more current seat ticket price and each of the one or more available seat ticket price;
communicating from the computing system across the network connection to the mobile device an indication of the one or more available seat ticket at the event and the change cost for the one or more available seat ticket;
receiving at the computing system across the network connection from the mobile device one or more selected seat ticket from the one or more available seat ticket;
receiving at the computing system an electronic delivery point for each one or more selected seat ticket; and
communicating each one or more selected seat ticket to the received electronic delivery point.

2. The method of claim 1 further comprising before the step of communicating each one or more selected seat ticket to the received electronic delivery point:
calculating by the computing system a final cost for the one or more selected seat ticket based on the change cost for the one or more selected seat ticket;
communicating from the computing system across the network connection to the mobile device the final cost;
determining at the computing system billing information for the final cost; and
receiving at the computing system across the network connection from the mobile device a confirmation to charge the final cost using the billing information.

3. The method of claim 1 wherein the change cost for the one or more available seat ticket is less than the price for the one or more available seat ticket.

4. method of claim 1 wherein the change cost for the one or more available seat ticket is more than the price for the one or more available seat ticket.

5. The method of claim 1 wherein the received electronic delivery point for each one or more selected seat ticket is the same.

6. The method of claim 1 wherein more than one selected seat ticket is communicated to the same received electronic delivery point.

7. The method of claim 1 wherein the change cost for the one or more available seat ticket is based on an occurrence during the event.

8. The method of claim 1 wherein the received request for one or more new seat ticket is received during an event.

9. The method of claim 1 wherein the received request for one or more new seat ticket is received before an event begins.

10. The method of claim 1 wherein determining billing information for the final cost comprises accessing an account of a user with at least one current seat ticket.

11. The method of claim 1 wherein the identification of the current seat ticket at an event comprises geolocating the mobile device of a user with at least one current seat ticket.

12. A system for mobile device-enabled electronic ticketing comprising:
a computing system configured to communicate through a network connection with a mobile device to identify one or more current seat ticket and to receive a request from the mobile device for one or more available seat ticket at an event; and
a venue store comprising information about seat tickets including a price for each of the seat tickets and an indication of whether each of the seat tickets is available for sale;
wherein the computing system is further configured to
communicate with the venue store to determine a price for each one or more current seat ticket and to identify one or more available seat ticket at the event and the ticket price for each of the one or more available seat ticket;
determine a change cost for each of the one or more available seat ticket, the change cost for each of the one or more available seat ticket being based on a difference in price between the one or more current seat ticket and the one or more available seat ticket;
communicate to the mobile device an indication of the one or more available seat ticket and the change cost for each of the one or more available seat ticket;
receive from the mobile device one or more selected seat ticket from the one or more available seat ticket;
receive from the mobile device one or more electronic delivery point for the one or more selected seat ticket; and
communicate the one or more selected seat ticket to the received one or more electronic delivery point.

13. The system of claim 12 wherein the computing system is further configured to
calculate a final cost for the one or more selected seat ticket based on the change cost for the one or more selected seat ticket;
communicate the final cost to the mobile device;
determine billing information for the final cost; and
receive from the mobile device a confirmation to charge the final cost based on the billing information.

14. The system of claim 12 wherein the network connection comprises a short messaging service gateway.

15. system of claim 12 wherein the one or more delivery point comprises an email address.

16. The system of claim 12 wherein the one or more delivery point comprises a short messaging service address or a mobile device number.

17. The system of claim 12 wherein the computing system communicates with the ⁻venue store through another network connection.

18. A non-transitory computer readable medium having stored thereupon computing instructions comprising:
a code segment to receive at a computing system a communication across a network connection from a mobile device, the communication including identification of one or more current seat ticket at an event and a request for one or more new seat ticket at the event;
a code segment to determine by the computing system a price for e one or more current seat ticket;
a code segment to determine by the computing system one or more available seat ticket at the event and a price for each of the one or more available seat ticket;
a code segment to calculate by the computing system a change cost for the one or more available seat ticket based on a difference between the one or more current seat ticket price and each of the one or more available seat ticket price;
a code segment to communicate from the computing system across the network connection to the mobile device an indication of the one or more available seat ticket at the event and the change cost for the one or more available seat ticket;
a code segment to receive at the computing system across the network connection from the mobile device one or more selected seat ticket from the one or more available seat ticket;
a code segment to receive at the computing system an electronic delivery point for each one or more selected seat ticket; and
a code segment to communicate each one or more selected seat ticket to the received electronic delivery point.

19. The non-transitory computer readable medium of claim 18 further comprising:
a code segment to calculate by the computing system a final cost for the one or more selected seat ticket based on the change cost for the one or more selected seat ticket;
a code segment to communicate from the computing system across the network connection to the mobile device the final cost;
a code segment to determine at the computing system billing information for the final cost; and
a code segment to receiving at the computing system across the network connection from the mobile device a confirmation to charge the final cost using the billing information.
